(19) United States
(12) Patent Application Publication
(10) Pub. No.: US 2010/0043039 A1
(43) Pub. Date: Feb. 18, 2010

(54) SYSTEM, METHOD AND APPARATUS FOR INTEGRATING MESSAGING WITH A TELEVISION

(75) Inventors: William Pat Price, Rhome, TX (US); Timothy Elliott, Huntington Beach, CA (US); Marcus Apitz, Yorba Linda, CA (US)

Correspondence Address: Law Office of Scott C Harris Inc, PO Box 1389, Rancho Santa Fe, CA, 92067, US

(73) Assignee: VIZIO, INC, Irvine, CA (US)

(21) Appl. No.: 12/190,980

(22) Filed: Aug. 13, 2008

(51) Int. Cl. H04N 7/173

(52) U.S. Cl. 725/109; 725/115

(57) ABSTRACT

An application for a digital television platform includes a display, a television receiver operatively coupled to the display and a processor operatively coupled to both the display and to the television receiver. A memory and a non volatile storage medium is communicably coupled to the processor. A communication link is also communicably coupled to the processor and a communication event is detected signaling reception of a communication on the communication link. Responsive to the communication event, a set of instructions is executed by the processor, the set of instructions is configured to receive the communication and to process the communication with respect to a set of user preferences.

### BACKGROUND

This disclosure relates to the field of televisions and more particularly to a system for integrating messaging into a television system.

Digital television systems are becoming more powerful as they handle more types of media and implement more user features such as digital video recording and high definition playback. Communication is becoming more ubiquitous in modern life. Email, text messages, instant messages, video conferencing, cellular telephones, voice over IP phones, and POTS (Plain Old Telephone Service) are commonplace.

With all the mediums for communication, many disparate devices are used. Each communication medium typically has a unique device associated with that medium. This causes the user of such communication medium to have multiple devices that perform the same or similar communication tasks.

Digital televisions typically have a display that allows the user to experience multimedia content. Digital televisions typically also have a television receiver for receiving signals that can be converted into multimedia content. Current standards for television signals include NTSC, ATSC, and QAM. Other television standards may also be used in these embodiments.

A processor is communicably coupled to the display to execute instructions that decode multimedia content from the receiver and present the multimedia content to the user on the display. These instructions are typically stored in a non volatile memory such as a ROM, EEPROM, flash memory, optical storage device, or magnetic storage devices. In a modern digital television system, there may be several sets of instructions; each with a different purpose. These instructions may be referred to as applications.

### SUMMARY

The inventor recognizes a need for a system that provides to a user a single location for viewing digital television content and responding to communications allowing the modern digital television to become the center of communications for a home or office.

An embodiment provides a system for the user to experience multimedia content as well as controlling communication to and from the user from a television. In an example embodiment, the system monitors one or more communication medium for communication. When a communication is detected, the system launches an application to interact with the communication and the user. In one example, the application includes instructions that convert spoken language to text and/or text to spoken language.

In this embodiment, the text is either overlaid on the multimedia content or the text is displayed on a portion of the display separate from the portion of the screen occupied by multimedia content. In embodiments where text is converted into spoken language, the voice for the spoken language is customizable; encompassing different genders, regional dialects, or other unique attributes of speech.

Another embodiment includes an application that translates the communication from a first language into a second language, thereby allowing users to communicate in their native language with others having a different native language.

A further embodiment includes an application that generates a response communication to the detected communication. For example the response communication informs or notifies the initiator of the communication that the intended recipient of the communication is occupied and may not immediately answer the communication. In addition to notifying the initiator that the intended recipient is occupied, the application records the communication letting the intended recipient respond to the communication at a later time. A further example embodiment may include notifications customized based on the initiator of the communication.

For example, communications initiated by contacts that are in a user's address book may be presented to the user, while communications initiated by contacts that are not in the user's address book may receive an automatic reply that the user is occupied and may not immediately answer the communication.

Yet another embodiment includes customized notifications based on the date and/or time of day.

A further embodiment includes redirecting the communication to an alternate receiving device such as a standard land-line telephone (e.g., Plain Old Telephone Service or POTS), a cellular telephone, a wireless handset or another receiving device connected to the digital television via a network.

In an embodiment, a digital television platform includes a display, a television receiver operatively coupled to the display and a processor operatively coupled to both the display and to the television receiver. A memory and a non volatile storage medium are communicably coupled to the processor. A communication link is also communicably coupled to the processor and a communication event is detected signaling reception of a communication on the communication link. Responsive to the communication event, a set of instructions is executed by the processor, the set of instructions is configured to receive the communication and to process the communication with respect to a set of user preferences.

In another embodiment, a method of a digital television interacting with communication includes receiving a digital television signal and displaying the digital television signal on a display device. The method includes detecting a communication event on a communication link, signaling the reception of a communication and processing the communication event based upon a set of parameters.

In another embodiment, computer readable medium encoded with a computer program includes instructions to cause a machine to receive a digital television signal and display the digital television signal on a display device. Instructions also detect a communication event on a communication link, signal the reception of a communication; and process the communication event based upon a set of parameters.

### BRIEF DESCRIPTION OF THE DRAWINGS

The embodiments can be understood by those having ordinary skill in the art by reference to the following detailed description when considered in conjunction with the accompanying drawings in which:

FIG. 1 illustrates a schematic view of a system of an embodiment;

FIG. 2 illustrates a first example of a user interface of an embodiment.

FIG. 3 illustrates a second example of a user interface of an embodiment.

FIG. 4 illustrates a third example of a user interface of an embodiment.

FIG. 5 illustrates a schematic diagram of an embodiment.

FIG. 6 illustrates a block diagram of an embodiment.

FIG. 7 illustrates a block diagram of a computer system of an embodiment.

FIG. 8 illustrates a fourth example of a user interface of an embodiment.

FIG. 9 illustrates a fifth example of a user interface of an embodiment.

FIG. 10 illustrates a flow chart of an embodiment.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

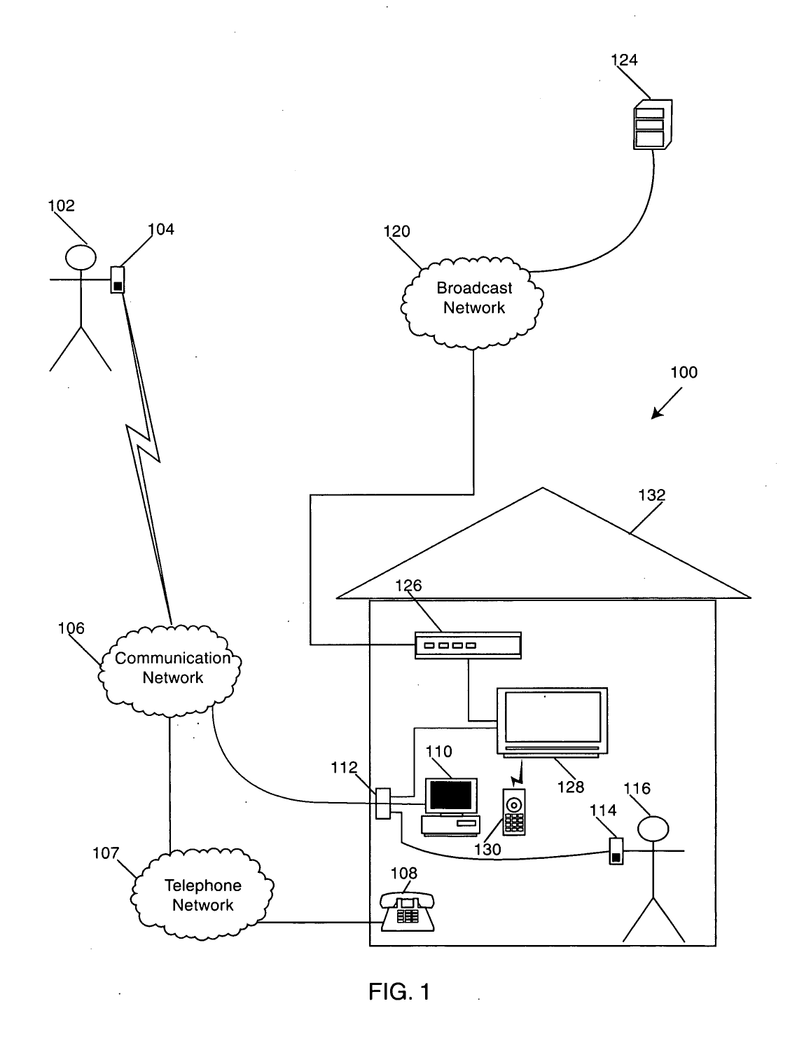

Referring to FIG. 1, a schematic view of a system 100 of an embodiment is shown. Television content emanates at a content source 124 such as a cable television head end, fiber optic head end or other transmission source. The television content disseminates over a broadcast network 120 and into a user's 116 home 132 where it is received by a receiver/modem such as a cable TV receiver, satellite receiver, broadcast receiver, etc. The receiver/modem 126 converts the broadcast television signal into a signal that is compatible with the television 128 such as High Definition Multimedia Interface (HDMI), S-Video, NTSC, PAL, RGB, etc.

A communications network 106 is connected to a modem within the user's home 132 such as a Data over Cable Service Interface Specification (DOCSIS) modem for cable internet access. The communications network 106 provides connectivity to other users 102. In this example, the other user 102 is using a handheld device 104 such as a cellular phone, personal digital assistant (PDA) or blackberry device to communicate with the first user 116. In this example, the first user 116 is also communicating using a handheld device connected (wired or wireless) to the modem 112.

A telephone network 107 is operatively coupled to the communications network 106 and interfaced to a telephone 108 within the user's home 132. The telephone network 107 is any known telephone network such as the digital cellular network or the POTS network.

The television 128 is also connected to the modem 112 to provide messaging services as will be described. Through such, messages from the communications network 106 (e.g., Internet) are directed to the television 128 for notification, display, response, etc. Additionally, through the same connection, the user's personal computer(s) connects with the television 128 for various functions including, but not limited to, changing preferences, entering/updating fixed responses, reviewing call lists, etc. As known in the industry, a remote control 130 is wirelessly interfaced to the television 128. In addition to controlling the television display and operation (as previously known), the remote control 130 is used by the user to navigate and dispose of incoming messages.

Being that the communications network 106 in operatively coupled to the telephone network 107, voice calls destine for the user's telephone 108 are, in some embodiments, routed through the communications network 106, through the modem 112 and to the television 128 for notification, display, response, etc.

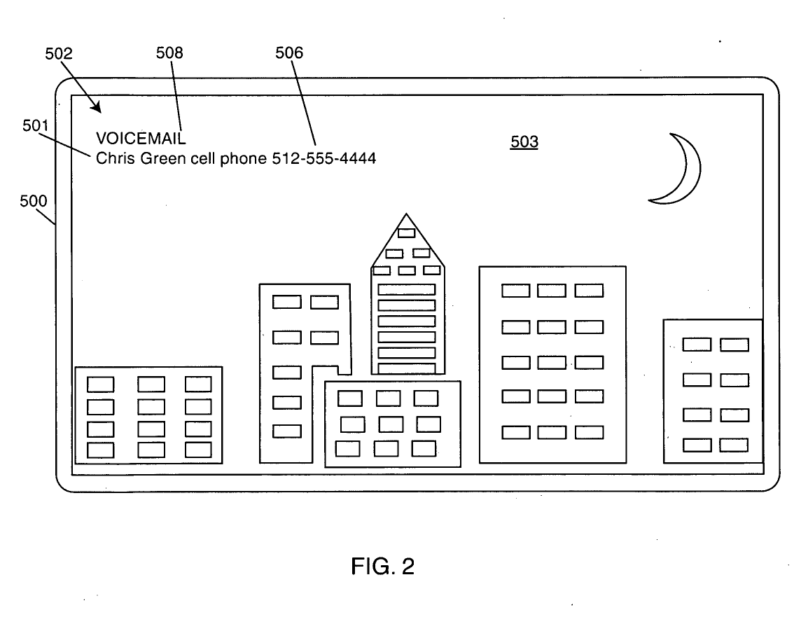

Referring to FIG. 2, a first example of a user interface 503 of the present invention is shown. In this, the television program is shown occupying the full screen 500 as known in the industry. In this example, a voicemail message has been received and a notification 502 indicating a voicemail 508, the originator 501 (Chris Green) and the originator's phone number 506 (512-555-4444) is overlaid on top of the television program.

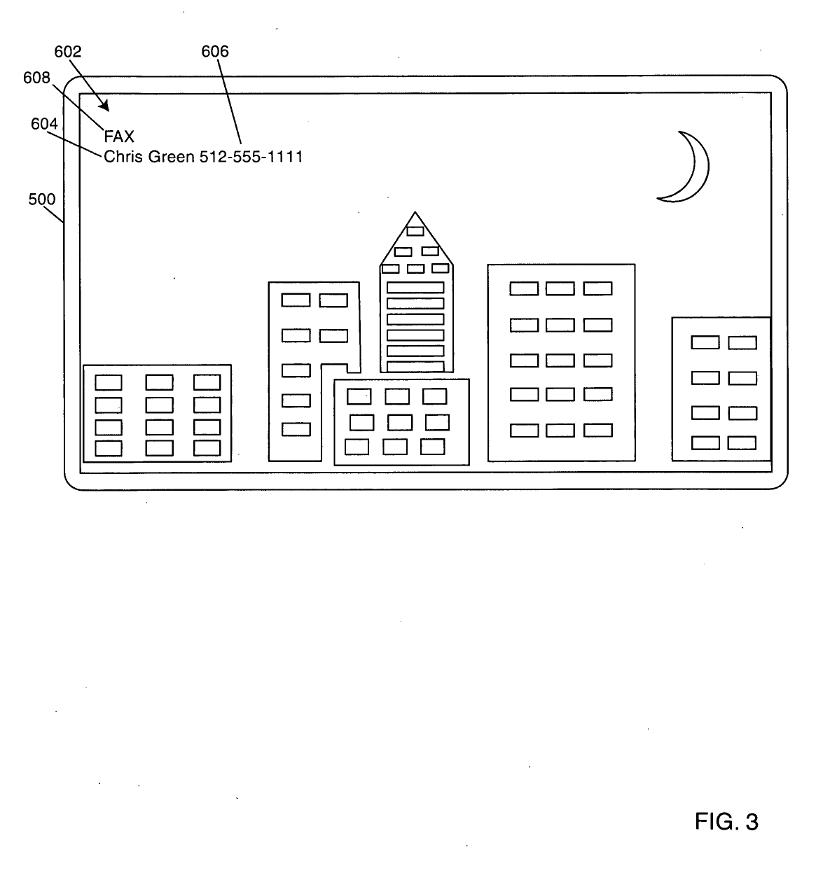

Referring to FIG. 3, a second example of a user interface is shown. In this, the television program is shown occupying the full screen 500 as known in the industry. In this example, a facsimile transmission (FAX) has been received and a notification 602 indicating a FAX 608, the originator 604 (Chris Green) and the originator's phone number 606 (512-555-1111) is overlaid on top of the television program.

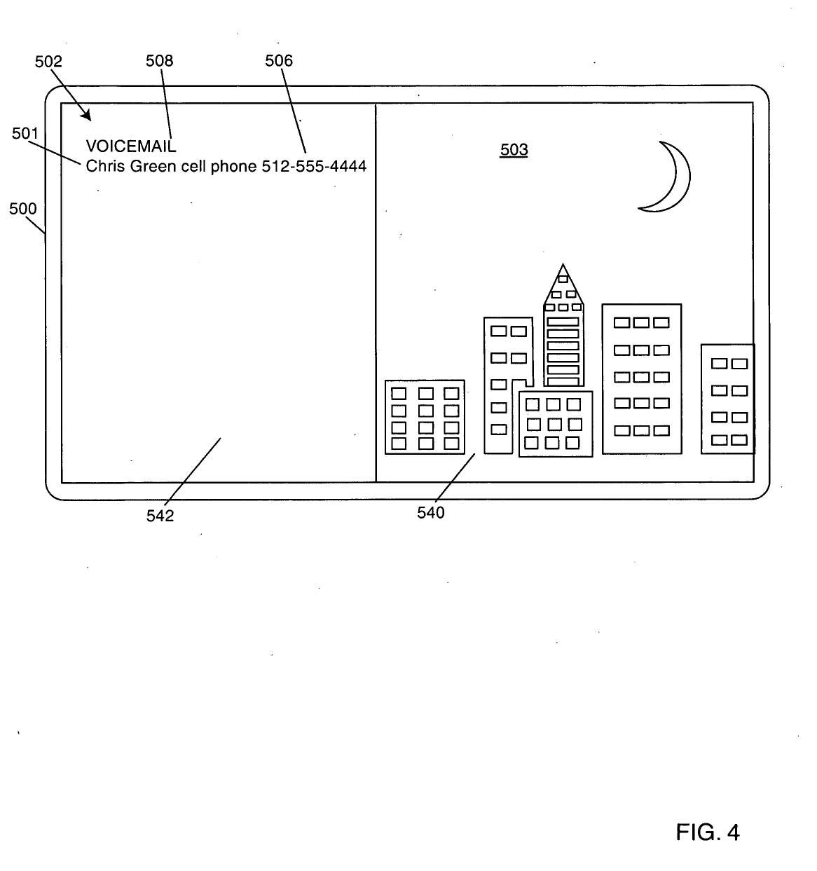

Referring to FIG. 4, a third example of a user interface is shown. In this, the television program is shown occupying less than a full screen 500 as known in the industry. The television program is reduced to fit in a subset or window 540 of the screen 500. As in FIG. 2, in this example, a voicemail message has been received and a notification 502 is displayed in a second window 542 indicating a voicemail 508, the originator 501 (Chris Green) and the originator's phone number 506 (512-555-4444). In some embodiments, some or the entire message is displayed within the second window 542. In embodiments in which the message is a voice message, the voice message is converted into a text message for display in the second window 542. In embodiments in which the message is a text message and in a different language than that understood by the user 116, the text message is translated from that language into a language that is understood by the user 116 and displayed in the second window 542.

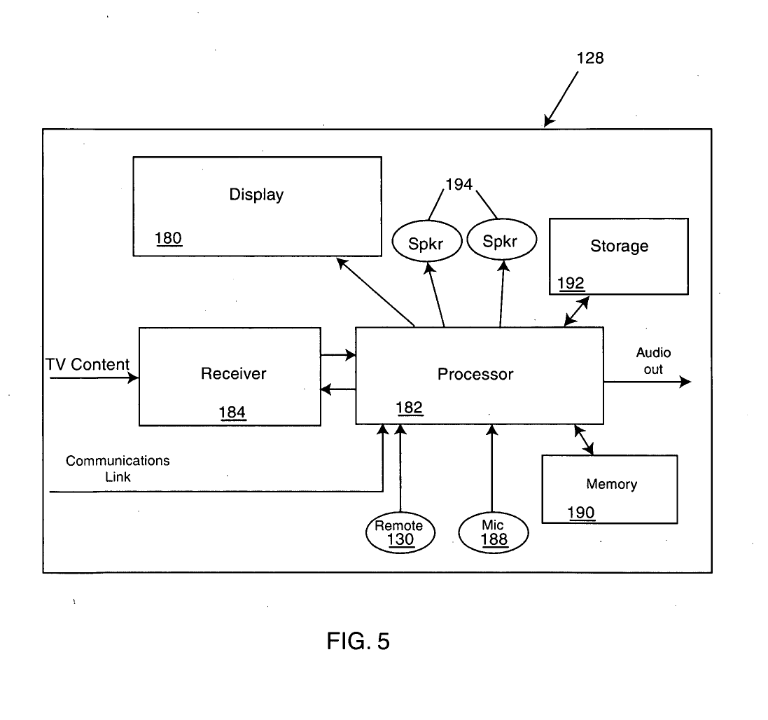

Referring to FIG. 5, a schematic diagram of a television 128 of the present invention is shown. The television 128 has a display 180 (e.g., tube, plasma, LCD, etc.) that is operatively coupled to a processor 182. The processor is coupled to a television receiver 184 which receives television content from any of various sources. Typically, one such source is air-wave broadcasts, satellite broadcasts, cable television, fiber optic television, etc. that are received by an external set top box 126 and transferred to the receiver 184 through protocols known in the industry such as HDMI,NTSC,S-VIDEO, etc. Alternately, the television content is a broadcast content such as digital television and the receiver 184 receives and decodes the television content as known in the industry for presentation on the display 180. The processor 182 accepts the content from the receiver 184 and displays the content on the display 180. The processor has persistent storage 192 for storing programs (e.g., FRAM, flash memory, etc.), data, preferences, security settings, etc., and memory 190 for temporary storage and program execution.

A communications link is connected to the processor 182 for, as an example, reception of messages, transmission or responses and television setup from a remote computer 110. As known in the industry, a remote control 130 is wirelessly interfaced to the processor 182. In addition to controlling the television display and operation (as previously known), the remote control 130 is used by the user to navigate and dispose of incoming messages. In some embodiments, a microphone 188 is operatively coupled to the processor 182 for accepting voice commands and/or responding to calls and messages. Speaker(s) 194 is/are provided for presenting audio television content and for reproducing audio messages.

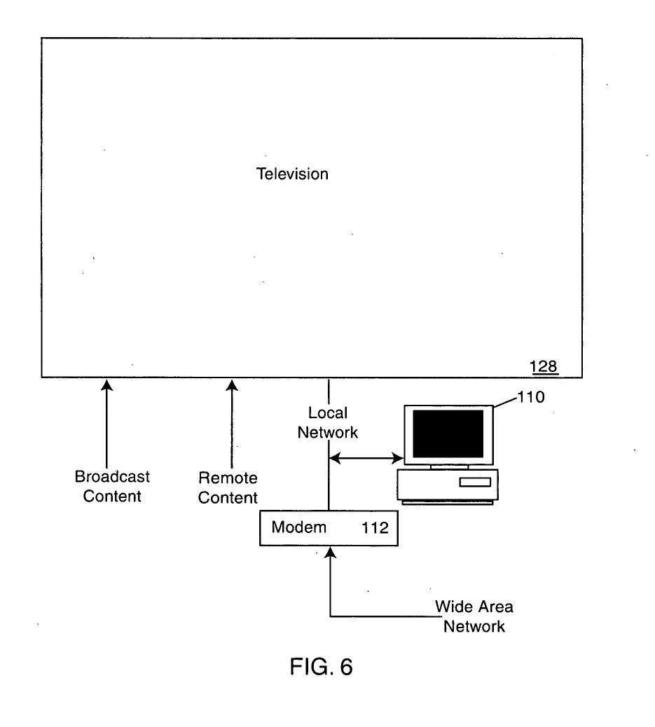

FIG. 6 illustrates a block diagram of an embodiment of the present invention is shown. The television 128 is connected to a home local area network (e.g., wireless such as or wired such as Ethernet over CAT5). The local area network connects to a modem 112 for receipt and transmission of messages as well as other uses such as receipt of Internet Television Broadcasts. In some embodiments, one or more user computers 110 are connected to the local network, providing connectivity between the user computers 110 and the wide area network (e.g., Internet) as well as connectivity to the television 128 to, for example, provide user interfaces to manage the television, manage the messaging operation of the television, etc. Also connected to the television are a remote control 130 and a source of broadcast television content.

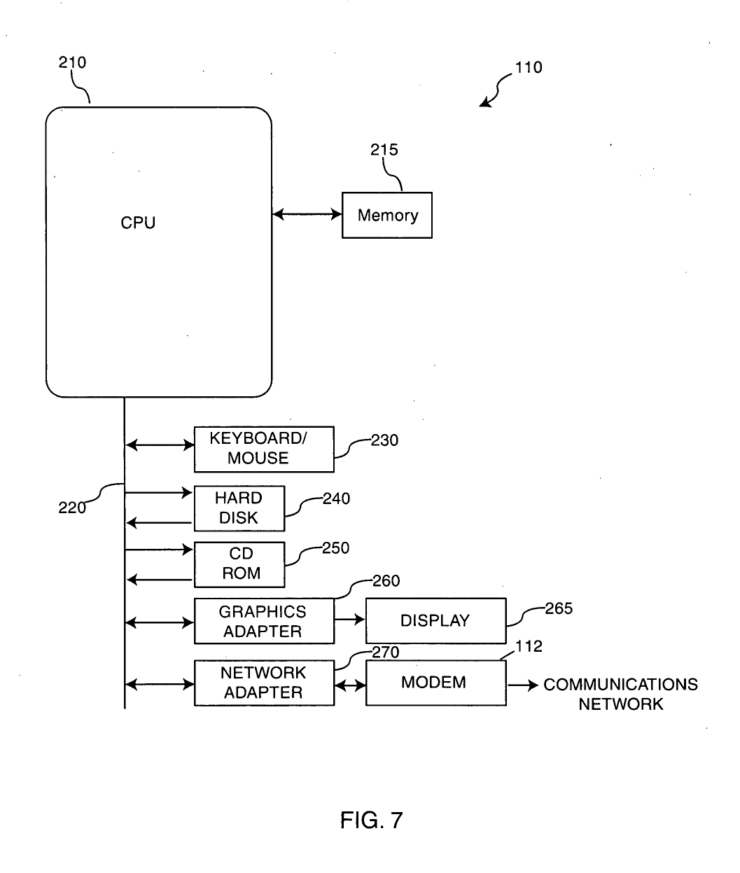

Referring to FIG. 7, a block diagram of a computer system 110 of an embodiment of the present invention is shown. Although shown in its simplest form, having a single processor, many different computer architectures are known that accomplish similar results in a similar fashion and the embodiments are not limited in any way to any particular computer system. The embodiments work well utilizing a single processor system as shown in FIG. 7, a multiple processor system where multiple processors share resources such as memory and storage, a multiple server system where several independent servers operate in parallel, e.g. having shared access to the data or any combination. In this, a processor 210 is provided to execute stored programs that are generally stored for execution within a memory 215. The processor 210 can be any processor or a group of processors, for example an Intel Pentium-4® CPU or the like. The memory 215 is connected to the processor and can be any memory suitable for connection with the selected processor 210, such as SRAM, DRAM, SDRAM, RDRAM, DDR, DDR-2, etc.

Also connected to the processor 210 is a system bus 220 for connecting to peripheral subsystems such as a network interface 270 with an IP Address 270, a hard disk 240, a CDROM 250, a graphics adapter 260 and a keyboard/mouse 230. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, etc. In some embodiments, other devices are connected to the system through the system bus 230 or with other input-output connections. Examples of these devices include printers; graphics tablets; joysticks; and communications adapters such as modems.

The network interface 270 connects the computer-based system to the communications network 106 through a local network and through a modem 112 such as a cable modem, fiber optic modem or telephone system modem.

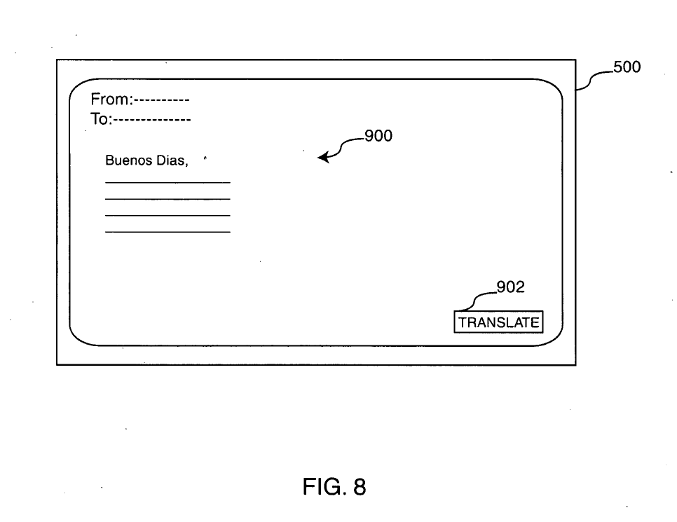

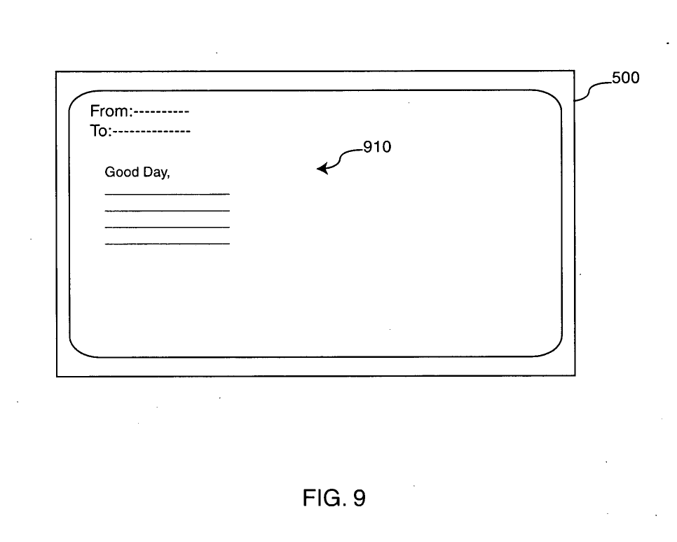

Referring to FIG. 8, a fourth example of a user interface is shown. In this, a message 900 has been received in Spanish. The user is able to view the message, scrolling with the use of their remote control 130. In some embodiments, the message is automatically translated based upon user preferences and detection of the language within the message while in other embodiments, the user initiates the translation by operating the translate function 902. Selecting the translate function with the remote control 130 results in the translation of the message and the user interface of FIG. 9.

Referring to FIG. 9, a fifth example of a user interface is shown. In this, the message originally received in Spanish 900 has been translated into an English message 910.

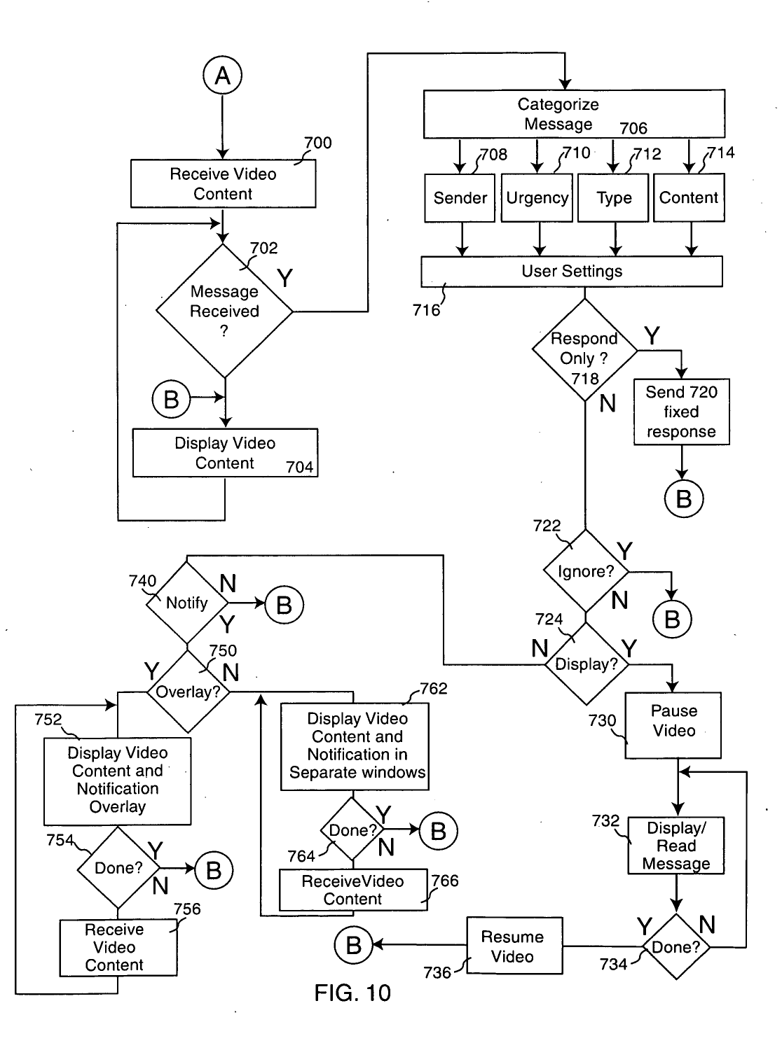

FIG. 10 shows a flow chart of an embodiment. Such a program is executed by the television processor 182 to receive the television content 700 and check for new messages 702 (e.g., message events).

Messages are, for example, telephone calls, text messages, incoming video conference calls, and incoming voice over IP calls. If no new messages are detected 702, the television content is displayed 704 on the display 180. If new messages are detected 702, the message(s) are categorized 706 to determine, for example, the sender 708, the urgency 710, the message type 712 and the content 714. Then, using user settings 716 such as the current activity of the user (e.g., stored preferences, status of the user—busy watching a movie) or the date or the time of day, the message is processed. If it is determined that a response should be sent 718 (e.g., no notification to the user), a fixed response is sent to the originator 720 and flow continues with displaying the television content 704.

If it is determined (based upon the user settings 716) that the message should be ignored 722 (e.g., no notification to the user), flow continues with displaying the television content 704. If it is determined (based upon the user settings 716) that the message needs to be displayed 724, the incoming television content is paused (if possible otherwise it is lost) and the message is displayed 732 on the display 180. The user interacts with the message 732 scrolling or paging up/down and alternately responding to the message 732 until they are done with the message 734 at which time the television content is resumed and flow continues with displaying the television content 704.

If it is determined (based upon the user settings 716) that a notification of the message is to be displayed 754, it is further determined 750 whether the notification is to be displayed as an overlay or in a separate window on the display 180. If it is determined that the notification is to be displayed as an overlay, the television content is displayed with the notification overlaid 752 on the display 180. Until the user acknowledges the notification indicating they are done 754, further television content is received 756 and displayed with the notification overlay 752. Once the user acknowledges the notification, indicating they are done 754, flow continues with displaying the television content 704. If it is determined that the notification is to be displayed in a separate window on the display 180, the television content is reduced and displayed in one section of the display 180 and the notification is displayed in a second window 762 of the display 180. Until the user acknowledges the notification indicating they are done 764, further television content is received 766 and displayed with the notification window 762. Once the user acknowledges the notification 764, indicating they are done, flow continues with displaying the television content 704.

In embodiments in which the message is a voice message, the voice message is selectively converted into a text message for display. In embodiments in which the message is a text message and received in a different language than that understood by the user 116, the text message is selectively translated from that language into a language that is understood by the user 116.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A digital television platform comprising:
a display;
a television receiver operatively coupled to the display, operable to display television content on the display;
a processor operatively coupled to the display and to the television receiver;
a memory communicably coupled to the processor,
a non volatile storage medium communicably coupled to the processor;
a communication link communicably coupled to the processor, said communication link detecting a communication event signaling reception of a communication on the communication link; and
said non-volatile storage medium storing a set of instructions executed by the processor responsive to the communication event, the set of instructions being configured to receive the communication and to process the communication with respect to a set of user preferences and to display at least one item of information regarding said communication on the same said display that displays said television content.

2. The digital television platform of claim 1, wherein the communication is a voice message and the set of instructions further includes instructions to convert voice message into a text message for display on the display.

3. The digital television platform of claim 1, wherein the communication is a voice message and the set of instructions further includes instructions to convert voice message into a text message and instructions to translate the text message from a first language into a second language for display on the display.

4. The digital television platform of claim 1, wherein the communication is a text message and the set of instructions further includes instructions to translate the text message from a first language into a second language for display on the display.

5. The digital television platform of claim 1, wherein the set of instructions further includes instructions to control the communication link to notify an originator of the communication that a recipient of the communication cannot answer.

6. The digital television platform of claim 5, wherein said notify is also customized based on a status, the status selected from the group consisting of a date, a time of day and a user activity.

7. The digital television platform of claim 1, wherein the communication is a text message and the set of instructions further include instructions to convert the text message into spoken language.

8. The digital television platform of claim 7, wherein the set of instructions further include instructions to select a voice for the spoken language, the voice having characteristics selected from the group consisting of gender and regional dialects.

9. The digital television platform of claim 1, wherein the communication is selected from the group consisting of a telephone call, a text message, a video conference, and a voice over IP call.

10. The digital television platform of claim 1, wherein the set of instructions further include instructions to record the communication.

11. The digital television platform of claim 1, wherein the set of instructions further include instructions to redirect the communication to an alternate device.

12. The digital television platform of claim 11 wherein the alternate device is selected from the group consisting of a POTS telephone, a cell phone, a wireless handset.

13. A method of a digital television interacting with communication comprising the steps of:
receiving a digital television signal;
displaying the digital television signal on a display device;
detecting a communication event on a communication link;
signaling the reception of a communication, said signaling including displaying information indicative of the reception on the same display device that displays the digital television signal; and
processing the communication event based upon a set of parameters.

14. The method of claim 13, wherein the communication is a voice message and the processing further includes converting the voice message into a text message.

15. The method of claim 13, wherein the communication is a text message and the processing further includes translating the text message from a first language to a second language.

16. The method of claim 13, wherein the processing further includes notifying an originator of the communication that the communication will not be answered.

17. The method of claim 13, wherein the processing further includes determining the originator and if the initiator is included on a list, notifying the originator of the communication that the communication will not be answered.

18. The method of claim 13, wherein the processing further includes determining the current time and if the current time is within a predetermined range, notifying an originator of the communication that the communication will not be answered.

19. The method of claim 13, wherein the communication is a text message and the processing further includes converting the text message to spoken language.

20. The method of claim 19, wherein the processing further includes selecting a voice for the spoken language, the voice having characteristics selected from the group consisting of gender and regional dialects.

21. The method of claim 13, wherein the communication is selected from the group consisting of a telephone call, a text message, an instant message, an incoming video conference call, and a voice over IP call.

22. The method of claim 13, wherein the processing further includes recording the communication.

23. The method of claim 13, wherein the processing further includes redirecting the communication to an alternate device.

24. The method of claim 23, wherein the alternate device is selected from the group consisting of a POTS telephone, a cell phone, a wireless handset.

25. A computer readable medium encoded with a computer program to cause a machine to:
receive a digital television signal;
display the digital television signal on a display device;
detect a communication event on a communication link; signal the reception of a communication; and
process the communication event based upon a set of parameters.

26. The medium of claim 25, wherein the communication is a voice message and the processing further includes converting the voice message into a text message.

27. The medium of claim 25, wherein the communication is a text message and the processing further includes translating the text message from a first language to a second language.

28. The medium of claim 25, wherein the processing further includes notifying an originator of the communication that the communication will not be answered.

29. The medium of claim 25, wherein the processing further includes determining the originator and if the initiator is included on a list, notifying the originator of the communication that the communication will not be answered.

30. The medium of claim 25, wherein the processing further includes determining the current time and if the current time is within a predetermined range, notifying an originator of the communication that the communication will not be answered.

31. The medium of claim 25, wherein the communication is a text message and the processing further includes converting the text message to spoken language.

32. The medium of claim 31, wherein the processing further includes selecting a voice for the spoken language, the voice having characteristics selected from the group consisting of gender and regional dialects.

33. The medium of claim 25, wherein the communication is selected from the group consisting of a telephone call, a text message, an instant message, an incoming video conference call, and a voice over IP call.

34. The medium of claim 25, wherein the processing further includes recording the communication.

35. The medium of claim 25, wherein the processing further includes redirecting the communication to an alternate device.

36. The medium of claim 35, wherein the alternate device is selected from the group consisting of a POTS telephone, a cell phone, a wireless handset.
